(19) United States
(12) Patent Application Publication
(10) Pub. No.: US 2008/0020962 A1
(43) Pub. Date: Jan. 24, 2008

(54) Production of High Active to Super High Active Surfactants in a Vacuum Neutralizer

(76) Inventor: Donald E. Oulman, Napperville, IL (US)

Correspondence Address: Jennifer E. Lacroix;McAndrews, Held & Malloy, 500 W. Madison Street, 34th Floor, Chicago, IL, 60661, US

(21) Appl. No.: 10/588,711

(22) PCT Filed: Feb. 11, 2004
(86) PCT No.: PCT/US04/04030

§ 371 Date: Apr. 30, 2007

(51) Int. Cl. C11D 11/00; C11D 1/12; C11D 1/26

(52) U.S. Cl. 510/495; 422/160

(57) ABSTRACT

A process for producing surfactant products by reacting, in a jacketed vacuum neutralizing reactor, the acid form of an anionic surfactant with a neutralizing agent, and supplementing heat to the reactor via a heat transfer medium on the jacket, which is not cooling water. The surfactant product made by such a process may exhibit a solids concentration of from about 50% by weight or greater. A vacuum reactor that has a heating jacket using a heat transfer medium, such as steam, that is not cooling water, and can function both as a neutralizing reactor and an evaporator is also contemplated.

### RELATED APPLICATIONS

[Not Applicable]

### BACKGROUND OF THE INVENTION

The present technology relates to a process for producing high active to super high active surfactants by reacting, in a jacketed vacuum neutralizer, the acid form of an anionic surfactant with a neutralizing agent, and providing supplemental heat to the neutralizer via a heat transfer medium on the jacket, such as steam, that is not cooling water. The present technology also relates to high active to super high active surfactants produced by such a process. In addition to the above, the present technology also provides a vacuum neutralizer that has a heating jacket which uses a heat transfer medium, such as steam, that is not cooling water. Such a vacuum neutralizer can function as both a neutralizing reactor and an evaporator.

An anionic surfactant is a component found in a variety of consumer products such as bar soaps, dish detergents, laundry detergents, liquid hand soap and the like. The manufacture of anionic surfactants for use in consumer products typically requires that a hydrophobic organic molecule, with a molecular weight of approximately 200 to 270, be sulfonated or sulfated with SO₃ to form a sulfonic acid or an alcohol sulfuric acid. The acid is then neutralized with one of a variety of neutralizing agents to form a surfactant product. The resultant surfactant product may then be combined with other ingredients to produce a finished consumer product.

Depending on the concentration in surfactant products, surfactants can be classified as low active, medium active or high active surfactants. Normally, a low or medium active surfactant product has a solids concentration lower than 50% by weight, while a high or very high active surfactant product typically contains about 50 to 83% solids by weight. Another class of surfactants called “dry surfactants” typically exhibit greater than 98% by weight solids.

One traditional method for producing concentrated surfactant products involves spray drying of low or medium active surfactant slurries. A slurry containing 35% to 50% water can be atomized in a spray drying tower to reduce moisture to below about 10%. However, the use of spray drying to make concentrated surfactant products has some disadvantages. For example, spray drying is energy intensive and the resulting surfactants must typically be in a non-sticky solid state to facilitate transport from the dryer system.

Another traditional method produces high active surfactant or detergent products by neutralization in a continuous neutralization loop. For example, a high active neutralizing system using a continuous neutralization loop is capable of producing high active (≧75 wt %) sodium alkyl benzene sulfonates and low molecular weight (C₁₂-C₁₄ and C₁₂-C₁₈) alcohol sulfates, while a very high active neutralization system using a continuous neutralization loop is capable of producing high active (≧75 wt %) high molecular weight (C₁₄-C₁₈ and C₁₆-C₁₈) alcohol sulfates and high active sodium alpha-olefin sulfonates. See Foster, et al., Medium to Very High Active Single Step Neutralization, The Chemithon Corporation (1997). Information of a typical continuous loop neutralizer can be found in, for example, U.S. Pat. No. 5,152,932 (Muller et al.) and EP 0 539 519 (Ofosu-Asante et al.).

More recently, continuous neutralization in a vacuum neutralizer has been used for making high active surfactants. U.S. Pat. No. 4,544,493 (Silvis), which is incorporated herein by reference in its entirety, provides a detailed description of a vacuum wiped film neutralizer that is typically used in the industry and capable of producing surfactant products containing about 50-85% by weight solids. Such a vacuum neutralizer can be modified based on the teaching of this specification to practice the presently described technology.

A neutralized surfactant mixture produced by a vacuum neutralizer existing in the prior art normally has a water content of at least about 15% by weight of the neutralized mixture. See U.S. Pat. No. 4,544,493 (Silvis, the “'493 patent”). Also, U.S. Pat. No. 5,152,932 (Muller et al.), when discussing continuous neutralization loops, states that it is “not practical to use a continuous neutralization system to attain low moisture levels (below about 12%)” in neutralized surfactant mixtures. Furthermore, super high active surfactants made from only sulfated or sulfonated acids are not typically desirable, since most consumer products consist of a mixture of primary surfactants, secondary surfactants (co-surfactants) and other additives to achieve the desirable characteristics of the ultimate final consumer products. The addition of co-surfactants and other additives to the primary surfactants, causes aqueous dilution effects, since many co-surfactants and additives contain water. Some additives may be anhydrous and do not cause aqueous dilution effects, but may include undesirable organic impurities or solvents in the final product due to their inclusion. Therefore, in the prior art, a vacuum evaporator or stripper has been used to farther dry the neutralized surfactant mixture to make super high active or dry surfactant products.

For example, the '493 patent noted above describes the use of a vacuum wiped film neutralizer to produce neutralized surfactants. The patent provides that the neutralized surfactant mixture can be subsequently transferred to a jacketed vacuum wiped film evaporator to remove water and to produce super high active or dry detergent salts having at least 92% active ingredient and no more than 6% water. However, the vacuum neutralizers in the prior art, such as the wiped film neutralizers described in the '493 patent or those available from Ballestra S.p.A. (Milan, Italy), do not incorporate external heating jackets. In the prior art, even if a jacket is part of a vacuum neutralizer, it is a cooling jacket utilizing, for example, circulated water of 140° F. or lower in the jacket to help control the reaction and product temperature. Before being dried in an evaporator, the surfactant mixtures produced by such vacuum neutralizers normally contain only 50% to 85% by weight solids of neutralized organic sulfates or sulfonates, co-surfactants, and/or other additives.

WO 01/09273 (Aouad et al.) and WO 03/010264 (Aouad et al.) describe the use of continuous drying equipment such as an agitated thin film evaporator (ATFE) to dry surfactant mixtures prepared by a continuous loop neutralizer or a batch neutralizer. Such ATFE equipment is operated under vacuum. After being dried in an ATFE, the resultant surfactant mixtures typically have a water content of less than 1% and no greater than 5%.

However, there are problems associated with the use of a vacuum evaporator in combination with a batch neutralizer, a prior art vacuum neutralizer or a loop neutralizer. Incorporation of such a device involves the expenditure of extra capital investment because two pieces of expensive equipment, i.e., a neutralizer and an evaporator, must be purchased. Additionally, extra energy has to be used in such two-stage systems. This results in increased energy costs due to the cooling of the surfactant mixtures in the neutralizer to remove the excess heat of neutralization, and the subsequent reheating of the surfactant mixtures in the evaporator to drive off the excess water to obtain the final product. Furthermore, when a vacuum evaporator is used in the prior art, drying temperatures of from about 90 to about 200° C. are typical. Such heightened temperatures will increase decomposition and crystallization of the resulting surfactants.

### BRIEF SUMMARY OF THE INVENTION

One object of the present technology is to provide an apparatus that can function both as a vacuum neutralizing reactor (vacuum neutralizer) and a vacuum evaporator for producing high to super high active surfactants.

Another object of the present technology is to provide a process for producing high to super high active surfactants using a vacuum neutralizer that can function both as a vacuum neutralizing reactor and a vacuum evaporator.

A further object of the present technology is to provide a process for producing high to super high active surfactants at mild temperatures to decrease surfactant decomposition and crystallization.

Other objects of the presently disclosed technology will become apparent to those skilled in the art who have the benefit of this specification and the prior art.

In one embodiment, there is provided a process for producing high to super high active surfactant products, including the steps of:
(1) feeding a neutralizing agent and an organic sulfuric or sulfonic acid or a combination thereof to a reaction zone within a vacuum reactor to form a reaction mixture.
(2) applying a vacuum pressure of greater than about 0 psia and less than about 15 psia to the reaction zone;
(3) heating the reaction zone via a heating jacket having a heat transfer medium which is not cooling water;
(4) agitating the reaction mixture in the reaction zone;
(5) reacting the neutralizing agent and the organic acid in the reaction zone to produce a salt;
(6) reducing the water content of the reaction mixture by evaporation in the reaction zone; and
(7) discharging a surfactant product from the vacuum reactor.

### The preferred heat transfer medium for the presently described technology is steam.

In accordance with another embodiment of the present technology, the process described above further includes the step of transferring the surfactant product to a mixer to incorporate additional additives, such as colorants or fragrances. The mixture discharged from the mixer can then be transferred to storage tanks for final disposition into tank trucks, drums, pails, or final packaging equipment. It should be understood by those skilled in the art that another contemplated embodiment of the presently described technology involves the surfactant products made by the above described process.

In a further embodiment, a jacketed vacuum neutralizer using a heat transfer medium, such as steam, is provided which can include:
a reaction zone;
a wall having an exterior and an interior surface where the interior surface surrounds the reaction zone;
at least one inlet opening in the wall for the introduction of a neutralizing agent and an organic sulfuric or sulfonic acid or a combination thereof to the reaction zone;
an agitator device mechanically disposed within the reaction zone or fixedly attached to the wall to agitate and react the organic sulfuric or sulfonic acid or the combination thereof and the neutralizing agent;
a vacuum device in communication with the reaction zone which provides the reaction zone with a vacuum pressure of greater than about 0 psia and less than about 15 psia; and
a heating device having a heat transfer medium, that is not cooling water, which is fixedly attached to the exterior surface of the wall and provides additional heat energy to the reaction zone.

### BRIEF DESCRIPTION OF SEVERAL VIEWS OF THE DRAWINGS

FIG. 1 is a schematic representation of the vacuum neutralizer of the present technology.

### DETAILED DESCRIPTION OF THE INVENTION

While the presently described technology will be described in connection with one or more preferred embodiments, it will be understood by those skilled in the art that the technology is not limited to only those particular embodiments. To the contrary, the presently described technology includes all alternatives, modifications, and equivalents as may be included within the spirit and scope of the appended claims.

The presently described technology encompasses a process to neutralize an organic sulfuric or sulfonic acid(s) or combinations thereof in a jacketed vacuum neutralizer having a heat transfer medium, such as steam, that is not cooling water for the production of surfactant products. As used in this specification, cooling water means water having a temperature lower than about 140° F., while a high temperature heat transfer medium means a medium maintained above about 150° F. Preferably, the heat transfer medium is an externally applied high temperature heat transfer medium such as steam, high temperature/high pressure water, an electrical heating element, and other vapor or liquid heat transfer media.

The presently described technology can be used to produce high active to super high active surfactants containing from about 50% to about 98% by weight solids. Thus, the surfactant products produced can be high or very high active surfactants, but are preferably super high active surfactants (SHAS) having a solids concentration of from about 83% to about 98% by weight. As a result, the surfactant products made by such a process, as well as the jacketed vacuum neutralizer used to perform that process, are also included within the scope and spirit of the presently described technology. Further, the active components of the surfactant products produced by the presently described technology such as neutralized organic sulfates and/or sulfonates are also included within the foregoing scope.

Suitable organic sulfuric or sulfonic acids that can be used in the presently described technology are the acid forms of any anionic surfactants which include, but are not limited to, organic sulfuric or sulfonic acids containing a higher lipophilic alkyl group of 8 to 20 carbon atoms in each acid molecule. For example, C₁₀-C₂₀ alkyl sulfuric acids, C₁₀-C₂₀ alkyl ether sulfuric acids, C₉-C₁₆ linear alkyl benzene sulfonic acids, C₁₂-C₁₈ methyl ester sulfonic acids or sulfonic acid fatty acids, C₁₂-C₁₈ alpha olefin sulfonic acids or disulfonic acids, and combinations thereof, are typical organic acids that can be neutralized to produce anionic surfactants based upon the presently described technology. Preferred organic sulfuric or sulfonic acids are C₁₂-C₁₈ alkyl sulfuric acids, C₁₂-C₁₈ alkyl ether sulfuric acids, C₁₂-C₁₈ methyl ester sulfonic acids or sulfonic acid fatty acids, C₁₂-C₁₈ alpha olefin sulfonic acids or disulfonic acids, and combinations thereof.

Organic sulfuric or sulfonic acids, i.e., surfactant acids, can be made by any sulfation/sulfonation process. For example, such acids can be sulfated or sulfonated with SO₃ in air in a falling film reactor like those offered by Chemithon Corporation (Chemithon Annular Falling Film Reactor or Chemithon Jet Reactor) (Seattle, Wash.), Ballestra S.p.A. (Ballestra Multitube Film Reactor) (Milan, Italy), or Stepan Company (Stepan Falling Film Multitube E Style Reactor or C+ Style Reactor) (Northfield, Ill.). Typical raw materials to produce surfactant acids include, but are not limited to, linear alkyl benzenes with C₁₁-C₁₃ alkyl chains, low molecular weight C₁₂-C₁₈ fatty alcohols, high molecular weight C₁₆-C₁₈ fatty alcohols, C₁₂-C₁₅ ethoxylated fatty alcohols (alcohol ethers) with 1-50 moles ethylene oxide per alcohol molecule, C₁₂-C₁₈ alpha olefins, C₁₂-C₁₈ fatty acids (preferably coconut fatty acid), and C₁₂-C₁₈ methyl esters.

Any neutralizing agent such as an alkali or alkaline earth metal hydroxide, an alkali metal carbonate or bicarbonate, an ammonium hydroxide, an amine, an alkanolamine, or a combination thereof can be used to neutralize the surfactant acids via the presently described technology. Preferably, the alkanolamines are utilized in an organic liquid or organic aqueous form, while the hydroxide or carbonate/bicarbonate neutralizing agents are used in the form of aqueous solutions or slurries. The aqueous neutralizing agent solution or slurry may be of any suitable concentration, but preferably will be in the range of from about 28% to about 85% by weight. Sodium hydroxide, preferably from about 48% to about 52% solids by weight, is the preferred alkali metal hydroxide, while triethanolamine (TEA), preferably from about 83% to about 87% organic liquid by weight, is the preferred alkanolamine.

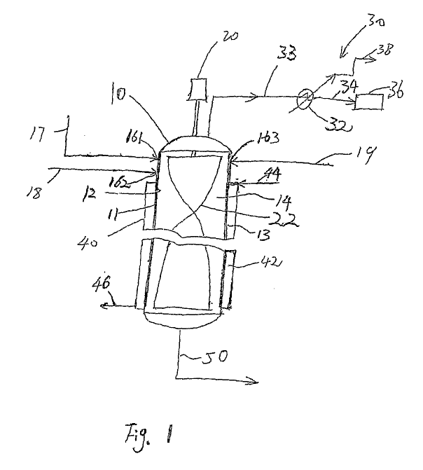

The surfactant acid can be neutralized by the neutralizing agent in a vacuum neutralizing reactor (also called a vacuum neutralizer) like that shown in FIG. 1. Any jacketed vacuum neutralizer, preferably a thin film or wiped film neutralizer such as that available from Ballestra S.p.A (Milan, Italy), can be modified based on the teaching of the presently described process and products produced therefrom. Preferably, the jacket is fixedly attached in an external maimer to the vacuum neutralizer.

FIG. 1 shows a vacuum wiped film reactor 10, which is externally jacketed and has a wall 11 having an interior surface 12 and an exterior surface 13, where the interior surface 12 surrounds a reaction zone 14 which comprises the interior space of the vacuum wiped film reactor 10. The reaction zone 14 provides space for both reaction and evaporation purposes. The vacuum wiped film reactor 10 is preferably vertically positioned and cylindrical in shape, although it can be positioned horizontally or on an incline. There is at least one inlet opening in the wall 11 for feeding the surfactant acid, the neutralizing agent, and co-surfactant or other additives (if any) into the reaction zone 14. FIG. 1 shows three inlet openings 161, 162 and 163 connected to the feeding lines 17, 18 and 19 for feeding the surfactant acid, the neutralizing agent, and additives that are stable in a high pH (basic) environment, respectively. However, a person of ordinary skill in the art will understand that the surfactant acid, the neutralizing agent, the co-surfactants, and/or other additives can be premixed and/or fed into the vacuum wiped film reactor 10 through the same inlet opening(s).

In accordance with one embodiment of the presently described technology, the neutralizing agent, such as an aqueous sodium hydroxide solution or slurry, is added by the feeding line 17 through the inlet opening 161. The inlet opening 161 is located a short distance above the inlet opening 162 which is connected to the feeding line 18 for the addition of the surfactant acid, such as a C₁₂-C₁₄ 2 mole ethoxylated alcohol ether sulfuric acid, into the reaction zone 14. The distance between the inlet openings 161 and 162 can be, for example, 1 to 24 inches. Such spacing prevents hydrolysis of the surfactant salt by acid and improves efficiency of the neutralization reaction in the reaction zone 14. A person of ordinary skill in the art will also understand that there can be one or more additional inlet openings (not shown) below the inlet opening 162 for feeding the surfactant acid into the reaction zone 14. Normally, from 2 to 18 inlet openings for feeding the surfactant acid can be employed, which are preferably in the upper portion of the vacuum wiped film reactor 10, although they can be distributed over the entire length of reaction zone 14 as needed.

In addition to the neutralizing agent and surfactant acid, any additives that can be combined with the neutralized surfactant salt to achieve desirable characteristics of the resultant surfactant product can be added to the vacuum reactor 10 to produce a reaction mixture. Such additives can include, but are not limited to, co-surfactants such as cationic, anionic, nonionic, ampholytic, zwitterionic surfactants, and combinations thereof. An example of such a co-surfactant can be Lauramine Oxide. Further information regarding such surfactants can be also found in, for example, U.S. Pat. No. 5,968,893 (Manohar et al.). Additionally, non-surfactant additives such as Coco Monoethanolamine can also be utilized. Thus, as used herein, co-surfactants are those materials that have surfactant characteristics while non-surfactant additives are any other additional materials that have beneficial properties for purposes other than surfactancy such as rheology modifiers, cosmetic agents or abrasives.

Additives that are stable in a basic environment, such as Laurmine Oxide, can be premixed and added by the feeding line 19 through the inlet opening 163 located in the proximity of the inlet opening 161, or can be premixed with the neutralizing agent and then added to the reaction zone 14 by the feeding line 17 through the inlet opening 161. Other desirable additives that are not stable in a basic environment, such as hydrolytically unstable polymers, can be added subsequent to introduction and neutralization of the surfactant acid through one or more inlet openings (not shown) located below the inlet opening 162.

While the reactants are preferably brought into the reaction zone 14 in the manner described above, it is within the scope and spirit of the present technology, for example, to feed the surfactant acid nearer to the top of the vacuum reactor 10 than the neutralizing agent, to employ plural neutralizing agent entries and/or a single surfactant acid entry, and to make other variations in the process, so long as both the surfactant acid and neutralizing agent are brought into film reaction contact within the reaction zone 14.

The vacuum wiped film reactor 10 can be equipped with an agitator 20 which rotates wiper blades (or scrapers) 22 to agitate the reaction mixture (not shown) in the reaction zone 14. The contents of the reaction mixture in the reaction zone 14 normally forms a film along the interior surface 12 of the wall 11. Blades or scrapers 22 can help move the mixture of contents in the reaction zone 14 with the aid of gravity, downwardly through the reaction zone 14 as well as outwardly onto the interior surface 12 of the wall 11, and can limit film buildup in the reaction zone 14. The reactants are preferably admitted to the reaction zone 14 near the top thereof, but below the upward position of the blades or scrapers 22. The blades or scrapers 22 preferably extend to within 1 to 6 inches (or 2 to 15 cm) of the top of the reaction zone 14. The topmost inlet(s) for the reactant(s)-which are openings 161 and/or 163 in FIG. 1 will preferably enter the reaction zone 14 at a height from 0.4 to 4 inches (or 1 to 10 cm) below the tops of the blades or scrapers 22. Other types of agitators capable of moving the mixture of contents or limiting film buildup in and along the reaction zone 14 are also encompassed by the spirit and scope of the presently described technology.

A vacuum is drawn on the reaction zone 14 by a vacuum device 30, which can include, for example, a condenser 32 and a vacuum pump (not shown), and vacuum device 30 is in communication with the reaction zone 14. The vacuum causes gaseous material, including condensables such as water vapors, to be withdrawn from the reaction mixture contents in the reaction zone 14 through a line 33 to the condenser 32, through a line 34 to a condensate receiver 36, or through a line 38 to the vacuum pump (not shown). The vacuum can be applied in such a manner that will cause countercurrent or concurrent vapor flow through the vacuum reactor 10. Preferably, the point of vacuum entry is at the bottom of the vacuum neutralizer.

Although not wanting to be bound by any particular theory, it is believed that the surfactant acid will react with the neutralizing agent in the reaction zone 14 to produce a surfactant salt. The neutralization reaction is believed to be exothermic. However, the reaction temperature must be controlled because overheating of the reaction mixture can lead to deterioration of the surfactant salt produced, for example, due to hydrolysis. Under vacuum, heat of neutralization is removed by vaporization of water (with the degree of vacuum controlling the reaction temperature).

Described in an alternative manner, it is believed that the adiabatic flash of water provides the cooling required to remove the heat of neutralization of the surfactant acid and the neutralizing agent such as a sodium hydroxide. Referring again to FIG. 1, water vapor is removed through the line 33, thereby reducing the water content of the reaction mixture in the reaction zone 14, which also concentrates and cools the surfactant salt. Such cooling is especially useful when the surfactant salt being made is heat sensitive, tending to decompose or thicken objectionably when heated.

Because the neutralization reaction generates heat, and such heat can degrade the resultant surfactant product, conventional wisdom dictates using a cooling device to remove heat from a continuous neutralizer rather than heating the neutralizer. For example, the '493 patent describes the use of a cooling jacket placed externally on a reactor to cool the neutralization reaction zone to prevent deterioration of the surfactant product. Such a vacuum neutralizer is available from Ballestra S.p.A. (Milan, Italy) as a wiped film vacuum neutralizer. Such prior art external cooling jackets employing cooling water typically exhibit a temperature of about 140° F. or lower.

When the neutralization reaction zone is not heated, as in the case of previously known vacuum neutralizers, it is believed that the reaction mixture in the reaction zone will subcool until the partial pressure of the water in the reaction mixture is equal to the pressure of the vacuum neutralizer after the heat of neutralization is exhausted by vaporization of the water. If such subcooling is too low, the reaction mixture may freeze or become very viscous. In order to prevent this from happening, the vacuum pressure has to be maintained above a certain level to control evaporation. If 140° F. or lower cooling water is utilized on the jacket, it may provide some energy input to maintain a pumpable product capable of exiting the vacuum neutralizer, but it cannot provide sufficient energy to produce super high active surfactant products.

Thus, referring back to FIG. 1, in accordance with one embodiment of the present technology, the vacuum wiped film reactor 10 is equipped with an external heating jacket which is fixedly attached to the exterior surface 13 of the wall 11. The reaction zone 14 is heated by passing an external high temperature heat transfer medium, such as steam, that is not cooling water, through a line 44 into the heating jacket 40 and through a line 46 , out of the heating jacket 40.

Other heat transfer media, for example, hot oil, high pressure/high temperature water or glycols, electrical heating elements, and other vapor or liquid heat transfer media such as Dowtherm® (available commercially from Dow Chemical Company of Midland, Mich.) or Mobiltherm® (available commercially from ExxonMobil Chemical of Houston, Tex.) can also be used in conjunction with the heating jacket 40, but steam is preferred. Thus, it should be understood by those skilled in the art that other heat transfer media capable of achieving the objects described herein are encompassed within the spirit and scope of the presently described technology.

A person of ordinary skill in the art will also understand that the heat transfer medium can enter and exit the heating jacket 40 at other positions; for example, it can enter at the position of the line 46, and then exit at the position of the line 44. But typically, when steam is used, it can be introduced at the high point of the heating jacket 40, and its condensate can be removed at the low point of the heating jacket 40; when a liquid-phase heat transfer medium is used, it can be introduced at the low point of the heating jacket 40 and be discharged at the high point of the heating jacket 40.

It should be further understood by those skilled in the art that the heating jacket of a vacuum neutralizer of the presently described technology does not have to be one continuous piece. For example, the vacuum neutralizer may comprise three separate jackets at the top, middle and bottom of the neutralizer which can be independently controlled.

When steam is used on the heating jacket 40, its pressure can be 0 psig or greater, preferably from about 0 psig to about 100 psig, more preferably from greater than about 0 psig to about 85 psig, most preferably from about 10 psig to about 25 psig; and its temperature can be 212° F. or greater, preferably in the range of from about 212° F. to about 338° F., more preferably from about 240° F. to about 267° F. It should be understood by those skilled in the art, however, that the steam can be operated at lower temperatures under vacuum. For example, steam from about 150° F. to about 212° F. with a pressure of from about 3.7 psia to about 15 psia can be used on the heating jacket 40 for the presently described technology.

When hot oil or electrical heating elements are used on the heating jacket 40, the heating temperature is typically 150° F. or greater, preferably from about 150° F. to about 338° F., more preferably from about 212° F. to about 338° F., most preferably from about 240° F. to about 267° F.

When high pressure/high temperature water (or a glycol such as an ethylene glycol) is used on the heating jacket 40, its temperature is typically 150° F. or greater, preferably from greater than about 150° F. to about 338° F., while its pressure can be maintained at about 14.5 psia or greater. Preferably, the high pressure/high temperature water can be operated at a temperature from about 212° F. to about 300° F., and at a pressure of from about 14.7 psia to about 100.0 psia, more preferably from about 14.7 psia to about 67.0 psia.

The heating jacket of the presently described technology using steam or high temperature/high pressure water or ethylene glycol will need to be rated for a high pressure and high temperature heat transfer medium compared to a conventional vacuum neutralizer equipped with a cooling water jacket.

Although not wanting to be bound by any particular theory, it is believed that the external high temperature heat transfer medium, such as steam, of the heating jacket 40, provides significant additional energy to the reaction zone 14 of the vacuum wiped film reactor 10. The additional energy can evaporate additional water of the neutralization reaction by-products, reactants and/or aqueous additives, such as amine oxides, betaines, amides, salt solutions, colorants, and fragrances. The additional energy can also evaporate volatile organic impurities or solvents derived from the reactants and/or additives. Therefore, the additional energy can achieve resultant SHAS products that have a solids concentration of from about 83% to about 98% by weight, preferably from about 87% to 95% by weight.

The discharged vapor stream is typically condensed in a heat exchanger, such as the condenser 32 of FIG. 1, prior to discharge to storage, waste treatment or recycling equipment.

The neutralization temperature in the reaction zone 14 can be controlled by the operating pressure of the vacuum wiped film reactor 10 and will not be significantly elevated by the heating jacket 40. Again, although not wanting to be bound by any particular theory, it is believed that by utilizing a lower operating pressure, a lower operating temperature within the reaction zone 14 can be achieved because more evaporation will happen at a lower operating pressure. However, how low the operating temperature (and then the operating pressure) can be is limited by the viscosity characteristics of the reaction mixture forming the resultant surfactant product. The viscosity of such materials can be such that the formed final product can flow to the discharge pump at the operating temperature. Thus, the operating temperature in the reaction zone can be from about 100° F. to about 158° F., preferably from about 110° F. to about 150° F., more preferably from about 130° F. to about 150° F. Further, the vacuum drawn on the reaction zone 14 can be in the pressure range of from greater than about 0 psia to less than about 15 psia, preferably from about 0.17 30 psia to about 9.67 psia, more preferably from about 0.96 psia to about 4.84 psia, most preferably from about 2.45 psia to about 4.4 psia.

The operation of the vacuum neutralizer can depend on various factors such as the water load in the incoming feeds, available steam pressure, operating pressure, desired water content or viscosity of the resultant neutralized surfactant product, et cetera. Careful adjustment of operating conditions will yield a surfactant product that achieves the desired moisture level at a low operating temperature. For example, the operating pressure can be modified/adjusted to yield the desired temperature in the vacuum neutralizer to achieve the ultimate solids concentration desired for the resultant surfactants produced by the vacuum neutralizer, which can be 50% by weight or greater, preferably from about 70% to about 98% by weight, more preferably from about 83% to about 98% by weight, even more preferably from about 87% to about 95% by weight.

It is preferable to maintain a low operating temperature in the vacuum neutralizer because a low operating temperature can reduce the decomposition or hydrolysis of temperature sensitive compositions such as an alcohol ether sulfate species. Moreover, such low operating temperatures can also prevent or reduce crystallization effects in the resultant neutralized surfactants which can occur at elevated operating temperatures. Thus, in accordance with one embodiment of the presently described technology, the vacuum neutralizer with an external heating jacket utilizing steam as a the heat transfer medium can be operated, for example, at about 1.0 psia and about 100° F. to yield a surfactant product containing about 2% by weight moisture, or at about 4.4 psia and about 156° F. to yield a surfactant product containing about 5% by weight moisture.

Referring again to FIG. 1, the surfactant product can be removed through a line 50, which is located at the bottom of the vacuum wiped film reactor 10. The surfactant product normally has a solids concentration of 50% by weight or greater, alternatively from about 70% to about 98% by weight, or alternatively from about 70% to about 83% by weight (high or very high active), or alternatively from about 83% to about 98% by weight (super high active). The surfactant product can then be transferred to a mixer such as a high shear mixer (not shown) to incorporate additives, including but not limited to, co-surfactants such as cationic, anionic, nonionic, ampholytic, or zwitterionic surfactants, enzymes, builders, chelating agents, clay-soil removal/anti-redeposition agents, bleaching agents, soil release polymers, polymeric dispersing agents, dye transfer inhibiting agents, brighteners, foam suppressors, fabric softeners, colorants, fragrances, rheology modifiers, cosmetic agents, abrasives, and combinations of any of the foregoing as well as other materials that will not negatively impact the product's free water concentration, which may not be suitable for addition to the vacuum wiped film reactor 10, prior to discharge into storage or shipping containers.

Alternatively, the surfactant product can be discharged directly to final form packaging equipment for final processing. The SHAS product discharged from the vacuum wiped film reactor 10, in general, has a viscosity of greater than about 100,000 cp, and can be used to produce products that are fluid and pumpable at an elevated temperature (such as from about 50 to about 60° C.), but can cool to a solid or semi-solid state at ambient temperature. The high or very high active surfactant product discharged from the vacuum wiped film reactor 10 has a lower viscosity typically between 25,000 cp to 100,000 cp. Thus, it should be understood by those skilled in the art that the high active to super high active surfactant product of the presently described technology has the advantage of being portable upon discharge from the vacuum wiped film reactor 10. Additionally, the surfactant product can be discharged in many different forms, including but not limited to, a paste, a liquid, a slurry, semi-solid, or a gel.

The presently described technology and its advantages will be better understood by reference to the following examples. These examples are provided to describe specific embodiments of the present technology. By providing these specific examples, the inventor does not limit the scope and spirit of the present technology. It will be understood by those skilled in the art that the full scope of the presently described technology encompasses the subject matter defined by the claims appending this specification, and any equivalents of the claims.

### EXAMPLES

### Water Contents of Raw Materials

The water contents of the raw materials for Examples 1-3 are as follows:

| Component | % Water |
|---|---|
| Sodium C₁₂₋₁₄ alcohol 2 mole ether sulfate | 0.0 |
| Sodium C₁₄₋₁₆ alpha olefin sulfonate | 0.0 |
| Sodium lauryl sulfoacetate | 67.5 |
| Cocoamidopropyl betaine | 65.0 |
| CocoamideMEA | 0.0 |
| Sodium alpha sulfomethylester sulfonate | 57.0 |
| Caustic | 50.0 |
| Water | 100.0 |

### Example 1

### Equipment and Materials

A 50% sodium hydroxide base and a pre-blend consisting of cocamidopropyl betaine solution and molten cocoamideMEA base are pumped to the top of a Ballestra S.p.A.(Milan, Italy) vertical vacuum neutralizer (VN) that has been modified in accordance with the presently described technology to accommodate external heating jackets utilizing steam as a heat transfer medium. A Stepan Company Falling Film Multitude E Style Reactor (sulfator or sulfonator) is used to produce a C₁₂₋₁₄ 2 mole ethoxylated alcohol ether sulfuric acid (SA).

The SA is then pumped to the improved VN below the addition point of the base and the pre-blend. The modified VN is then connected via piping to a condenser and vacuum pump to provide sub-ambient operating pressure capability, i.e., a vacuum. Steam is subsequently piped to the external heating jackets of the modified VN using individual steam pressure regulators.

The evaporated water discharges through the condenser and is collected as liquid water and subsequently disposed thereof. The product exiting the bottom of the modified VN is pumped by a Blackmer (Grand Rapids, Mich.) positive displacement pump to a Ballestra S.p.A. (Milan, Italy) post-high shear mixer capable of mixing colorants, fragrance and other additives to the SHAS mixture produced. The SHAS product is finally transferred to drums for storage.

### Operation

The pressure of the modified VN is reduced to about 4 psia via the condenser and vacuum pump. The 50% sodium hydroxide base and the pre-blend consisting of cocoamidopropyl betaine solution and molten cocoamideMEA are pumped to the top of the modified VN. The rotating wiper element of the modified VN distributes the mixture uniformly as a thin film on the internal circumference of the modified VN. The sulfator is started and the resultant SA is pumped to the modified VN about 25 cm (10 inches) below the base and the pre-blend. The SA is neutralized by the base to form a sodium salt of the SA to a pH of from about 7 to about 8 and is comixed with the pre-blend material at that time in the overall process. The heat of neutralization provides some of the heat required to evaporate water from the surfactant blend materials. The steam pressure on the modified VN unit's top, middle and bottom jackets is adjusted to about 15 psig to accomplish additional evaporative water removal to achieve a final surfactant product moisture concentration. The SHAS product discharged from the modified VN is pumped away from the modified VN using the positive displacement pump to the post-high shear mixer. Water soluble colorants and fragrance are subsequently pumped into the bottom mixing chambers of the post-high shear mixer to achieve a uniform, colored, and fragrant SHAS product. The product discharged from the post-high shear mixer is then finally placed into storage drums.

Upon achieving desired quantities of the SHAS product, the sulfator and VN feeds are stopped and cleaned. The SHAS product is allowed to cool in the drums. Upon cooling, the SHAS product becomes a semi-soft product. The SHAS product can be reheated and pumped to final product packaging equipment as necessary.

For comparison purpose, another surfactant product is produced by a standard Ballestra VN that is not equipped with an external heating jacket utilizing steam as a heat transfer medium of the presently described technology, but continuing to use the same starting materials and operating conditions as described above.

### Results

The surfactant products of Example 1 discharged from a modified VN with steam and a standard VN without steam are analyzed. Weight distribution characteristics of the surfactant products were calculated via HYSYS modeling, and are provided in the following table:

| | w/steam | w/out steam |
|---|---|---|
| Component | wt % | wt % |
| Sodium C₁₂₋₁₄ alcohol 2 mole ether sulfate | 70.6 | 57.5 |
| Cocoamidopropyl betaine | 13.6 | 11.1 |
| CocoamideMEA | 7.8 | 6.4 |
| Water | 8.0 | 25.0 |

HYSYS is a chemical process modeling software package manufactured by Hyprotech, a subsidiary of Aspen Technology, Inc. (Cambridge, Mass.). The data indicates that the resultant surfactant product prepared by the presently described technology exhibits a moisture concentration of 8.0% by weight and a solids concentration of 92.0% by weight and is a SHAS product, while the surfactant product made by the prior art technology exhibits a water concentration of 25.0% by weight.

### Example 2

Equipment and Materials

A 50% sodium hydroxide base and a pre-blend consisting of sodium lauryl sulfoacetate, cocoamidopropyl betaine and cocoamideMEA are pumped to the top of a modified Ballestra S.p.A. (Milan, Italy) VN. A Stepan Company falling film sulfator is used to produce a C₁₄-C₁₆ alpha olefin sulfonic acid (SA). The SA is then pumped to the modified VN below the addition point of the base, co-surfactant and other additives. Other equipment and conditions used are the same as Example 1.

### Operation

The pressure of the modified VN is reduced to about 4 psia via the condenser and vacuum pump. The 50% sodium hydroxide base and pre-blend consisting of sodium lauryl sulfoacetate, cocoamideopropyl betaine and cocoamideMEA is pumped to the top of the modified VN. The rotating wiper element of the modified VN distributes the mixture uniformly as a thin film on the internal circumference of the modified VN. The sulfonator is started, and the resultant SA is pumped to the modified VN about 25 cm (10 inches) below the base and pre-blend. The SA is neutralized by the base to form a sodium salt of the SA with a pH of from about 7 to about 8 and is commixed with the pre-blend materials. The heat of neutralization provides a portion of the heat required to evaporate water from the surfactant blend material. At a point about 60 cm (23.6 inches) below the SA addition point, ethylene glycol distearate is pumped to the modified VN. The steam pressure on the modified VN unit's top, middle and bottom jackets are adjusted to about 15 psig to accomplish additional evaporative water removal to achieve a final surfactant product moisture concentration. The SHAS product discharged for the modified VN is subsequently pumped using the positive displacement pump through the post-high shear mixer. Water soluble colorants and fragrance are pumped into the bottom mixing chambers of the post mixer to achieve a uniform colored and fragrant SHAS product. The product is then discharged from the post-high shear mixer and drummed.

Upon achieving desired quantities of the SHAS product, the sulfator and modified VN feeds are stopped and subsequently cleaned. The SHAS product is allowed to cool in the drums. Upon cooling, the SHAS becomes a semi-soft product. The SHAS product can be reheated and pumped to final product packaging equipment if necessary.

For comparison purpose, another surfactant product is produced by a standard Ballestra VN that is not equipped with an external heating jacket utilizing steam as a heat transfer medium of the presently described technology, but continuing to use the same starting materials and operating conditions as described above.

### Results

The surfactant products of Example 2 discharged from a modified VN with steam and a standard VN without steam are analyzed. Weight distribution characteristics of the surfactant products were calculated via HYSYS modeling, and are provided in the following table:

| | w/steam | w/out steam |
|---|---|---|
| Component | wt % | wt % |
| Sodium C₁₄₋₁₆ alpha olefin sulfonate | 38.2 | 20.4 |
| Sodium lauryl sulfoacetate | 12.0 | 6.4 |
| Cocoamidopropyl betaine | 35.8 | 19.0 |
| CocoamideMEA | 6.0 | 3.2 |
| Water | 8.0 | 51.0 |

The data illustrates that the SHAS product produced by the presently described technology has a moisture concentration of 8.0% by weight and a solids concentration of 92.0% by weight, and the surfactant product made by the prior art technology has a water concentration of as high as 51.0% by weight.

### Example 3

### Equipment and Materials

A 50% sodium hydroxide base and a pre-blend consisting of a cocamidopropyl betaine solution and a molten cocoamideMEA are pumped to the top of a modified vertical Ballestra S.p.A. (Milan, Italy) VN according to the presently described technology. A Stepan Company falling film sulfator is used to produce a C₁₂₋₁₄ 2 mole ethoxylated alcohol ether sulfuric acid (SA). The SA is pumped to the modified VN below the addition point of the base, the pre-blend and other additives. Sodium alphasulfomethylester sulfonate, a co-surfactant, is pumped to the modified VN about 60 cm (23.6 inches) below the acid addition point. Other equipment and conditions used are the same as Example 1.

### Operation

The VN pressure is reduced to about 4 psia via the condenser and vacuum pump. The 50% sodium hydroxide base and pre-blend consisting of cocoamidopropyl betaine solution and molten cocoamideMEA are pumped to the top of the modified VN. The rotating wiper element of the modified VN distributes the mixture uniformly as a thin film on the internal circumference on the modified VN. The sulfator is then started, and the SA is pumped to the modified VN about 25 cm (10 inches) below the base and pre-blend. The SA is neutralized by the base to form a sodium salt of the SA to a pH of from about 7 to about 8 and is commixed with the pre-blend material. The heat of neutralization provided a portion of the heat required to evaporate water from the surfactant blend materials. At a point about 60 cm (13.6 inches) below the SA addition point, the sodium alphasulfomethylester sulfonate is pumped to the modified VN. The sodium alphasulfomethylester sulfonate contains about 6% w/w methanol. The steam pressure on the modified VN unit's top, middle and bottom jackets are adjusted to about 15 psig to accomplish additional evaporative water removal and evaporative methanol removal to achieve a final surfactant product moisture and methanol concentration. The SHAS product discharged from the modified VN is subsequently pumped using the positive displacement pump through the post-high shear mixer. Colorants and fragrance are subsequently pumped into the bottom mixing chambers of the post-high shear mixer to achieve a uniform, colored, and fragrant SHAS product. The resultant product is subsequently discharged from the post-high shear mixer and then drummed.

Upon achieving desired quantities of the SHAS product, the sulfator and modified VN feeds are stopped and the equipment is cleaned. The SHAS product is allowed to cool in the drums. Upon cooling, the SHAS becomes a semi-soft product. The SHAS product can be reheated and pumped to final product packaging equipment, if necessary.

For comparison purpose, another surfactant product is produced by a standard Ballestra VN that is not equipped with an external heating jacket utilizing steam as a heat transfer medium of the presently described technology, but continuing to use the same starting materials and operating conditions as described above.

### Results

The surfactant products of Example 3 discharged from a modified VN with steam and a standard VN without steam are analyzed. Weight distribution characteristics of the surfactant products were calculated via HYSYS modeling, and are provided in the following table:

| | w/steam | w/out steam |
|---|---|---|
| Component | wt % | wt % |
| Sodium C₁₂₋₁₄ alcohol 2 mole ether sulfate | 35.2 | 21.1 |
| Sodium alpha sulfomethylester sulfonate | 35.2 | 21.1 |
| Cocoamidopropyl betaine | 13.5 | 8.0 |
| CocoamideMlEA | 7.8 | 4.6 |
| Water | 8.0 | 44.1 |
| Methanol | 0.3 | 1.1 |

The data indicates that methanol is substantially removed from the SHAS product, which exhibits a solids concentration of 91.7%. The surfactant product made by the prior art technology still contains 1.1% by weight methanol and has a water concentration of as high as 44.1% by weight.

The present technology is now described in such full, clear, concise and exact terms as to enable any person skilled in the art to which it pertains, to practice the same. It is to be understood that the foregoing describes preferred embodiments of the invention and that modifications may be made therein without departing from the spirit or scope of the present technology as set forth in the appended claims. A person of ordinary skill in the art will also understand that besides removing water, the present technology can substantially remove volatiles or organic solvents, such as 1,4-dioxane or methanol, from the SHAS products made in accordance with the present technology.

What is claimed is:

1. A process for producing a high to super high active surfactant product comprising the steps of:
feeding a neutralizing agent and an organic acid to a reaction zone of a vacuum reactor, wherein the organic acid is a sulfuric or sulfonic acid or a combination thereof to form a reaction mixture;
applying a vacuum pressure of greater than about 0 psia and less than about 15 psia to the reaction zone;
heating the reaction zone via a heating jacket having a heat transfer medium, wherein the heat transfer medium is not cooling water;
agitating the reaction mixture in the reaction zone;
reacting the neutralizing agent and the organic acid in the reaction zone to produce a salt;
reducing the water content of the reaction mixture by evaporation in the reaction zone; and
discharging a surfactant product from the vacuum reactor.

2. The process of claim 1, wherein the neutralizing agent comprises an alkali or alkaline earth metal hydroxide, an alkali metal carbonate or bicarbonate, an ammonium hydroxide, an amine, an alkoanolamine, or a combination thereof; and wherein the organic acid comprises a C₁₀-C₂₀ alkyl sulfuric acid, a C₁₀-C₂₀ alkyl ether sulfuric acid, a C₉-C₁₆ linear alkyl benzenie sulfonic acid, a C₁₂-C₁₈ methyl ester sulfonic acid or sulfonic acid fatty acid, a C₁₂-C₁₈ alpha olefin sulfonic acid or disulfonic acid, or a combination thereof.

3. The process of claim 1, wherein the neutralizing agent comprises sodium hydroxide; and wherein the organic acid comprises a C₁₂-C₁₅ alkyl sulfuric acid, a C₁₂-C₁₈ alkyl ether sulfuric acid, a C₁₂-C₁₈ alpha olefin sulfonic acid, or combinations thereof.

4. The process of claim 1, wherein the vacuum reactor is a thin film or wiped film reactor, and wherein the reaction mixture is capable of forming a film in the reaction zone.

5. The process of claim 1, further comprising the step of feeding co-surfactants or other non-surfactant additives to the reaction zone.

6. The process of claim 5, wherein the co-surfactants added to the reaction zone comprise a cationic surfactant, an anionic surfactant, a nonionic surfactant, an ampholytic surfactant, a zwitterionic surfactant, or a combination thereof.

7. The process of claim 5, wherein the other non-surfactant additives added to the reaction zone comprise rheology modifiers, cosmetic agents, abrasives, or combinations thereof.

8. The process of claim 1, wherein the neutralizing agent is fed to the reaction zone before the organic acid is fed to the reaction zone.

9. The process of claim 1, wherein the vacuum pressure is from about 0.17 psia to about 9.67 psia.

10. The process of claim 1, wherein the heat transfer medium is a vapor or a liquid heat transfer media having a sufficient temperature and a sufficient pressure.

11. The process of claim 10, wherein the sufficient temperature of the vapor heat transfer media is from about 212° F. or greater and the sufficient pressure is from about 0 psig or greater.

12. The process of claim 10, wherein the sufficient temperature of the liquid heat transfer media is from about 150° F. or greater and the sufficient pressure is from about 14.5 psia or greater.

13. The process of claim 1, wherein the heat transfer medium is steam.

14. The process of claim 13, wherein the pressure of the steam is about 0 psig or greater and the temperature of the steam is about 212° F. or greater.

15. The process of claim 13, wherein the pressure of the steam is from about 3.7 psia to about 15 psia and the temperature of the steam is from about 150° F. to about 212° F.

16. The process of claim 1, wherein the heat transfer medium is an oil or an electric heating element having a sufficient temperature.

17. The process of claim 16, wherein the sufficient temperature of the oil or the electric heating element is about 150° F. or greater.

18. The process of claim 1, wherein the heat transfer medium is water or a glycol having a sufficient temperature and a sufficient pressure.

19. The process of claim 18, wherein the sufficient temperature of the water or the glycol is about 150° F. or greater and the sufficient pressure is about 14.5 psia or greater.

20. The process of claim 1, wherein the surfactant product has a solids concentration of about 50% by weight or greater.

21. The process of claim 1, wherein the surfactant product has a solids concentration of from about 70% to about 98% by weight.

22. The process of claim 1, wherein the surfactant product has a solids concentration of from about 83% to about 95% by weight.

23. The process of claim 1, further comprising the step of transferring the surfactant product to a mixer to incorporate at least one additive.

24. The process of claim 23, wherein the additive added to the mixer comprises a colorant, a co-surfactant, an enzyme, a builder, a chelating agent, a clay-soil removal or anti-redeposition agent, a bleaching agent, a soil release polymer, a polymeric dispersing agent, a dye transfer inhibiting agent, a brightener, a foam suppressor, a fabric softener, a fragrance, a rheology modifier, a cosmetic agent, an abrasive, or a combination thereof.

25. The process of claim 1, wherein the surfactant product is discharged from the vacuum reactor in a form comprising a paste, a liquid, a slurry, a semi-solid, or a gel.

26. A surfactant product produced by a process comprising the steps of:
feeding a neutralizing agent and an organic acid to a reaction zone of a vacuum reactor, wherein the organic acid is a sulfuric or sulfonic acid or a combination thereof to form a reaction mixture;
applying a vacuum pressure of greater than about 0 psia and less than about 15 psia to the reaction zone;
heating the reaction zone via a heating jacket having a heat transfer medium, wherein the heat transfer medium is not cooling water;
agitating the reaction mixture in the reaction zone;
reacting the neutralizing agent and the organic acid in the reaction zone to produce a salt;
reducing the water content of the reaction mixture by evaporation in the reaction zone; and
discharging a surfactant product from the vacuum reactor.

27. The surfactant product of claim 26, wherein the surfactant product has a solids concentration of about 50% by weight or greater.

28. The surfactant product of claim 26, wherein the surfactant product has a solids concentration of from about 70% to about 98% by weight.

29. The surfactant product of claim 26, wherein the surfactant product has a solids concentration of from about 83% to about 95% by weight.

30. The surfactant product of claim 26, wherein the heat transfer medium is steam and the heat transfer medium is maintained at a pressure of about 0 psig or greater and a temperature of about 212° F. or greater.

31. The surfactant product of claim 26, wherein the heat transfer medium is steam and the heat transfer medium is maintained at a pressure of from about 3.7 psia to about 15 psia and a temperature of from about 150° F. to about 212° F.

32. The surfactant product of claim 26, wherein the surfactant product is discharged from the vacuum reactor in a form comprising a paste, a slurry, a semi-solid, a liquid, or a gel.

33. A vacuum neutralizing reactor for producing a surfactant product, comprising:
a reaction zone;
a wall having an exterior surface and an interior surface, wherein the interior surface surrounds the reaction zone;
at least one inlet opening in the wall for the introduction of a neutralizing agent and an organic sulfuric or sulfonic acid or a combination thereof to the reaction zone;
an agitator device disposed within the reaction zone or fixedly attached to the wall to agitate and react the organic sulfuric or sulfonic acid or the combination thereof and the neutralizing agent;
a vacuum device in communication with the reaction zone to provide the reaction zone with a vacuum pressure of greater than about 0 psia and less than about 15 psia; and
a heating device having a heat transfer medium that is not cooling water, and wherein the heating device is fixedly attached to the exterior surface of the wall to provide heat energy to the reaction zone.

34. The vacuum neutralizing reactor of claim 33, wherein the heating device comprises an external heating jacket; and wherein the heat transfer medium is steam maintained at a pressure of about 0 psig or greater and a temperature of about 212° F. or greater.

35. The vacuum neutralizing reactor of claim 33, wherein the heating device comprises an external heating jacket; and wherein the heat transfer medium is steam maintained at a pressure of from about 3.7 psia to about 15 psia and a temperature of from about 150° F. to about 212° F.

36. The vacuum neutralizing reactor of claim 33, wherein the heating device comprises an external heating jacket; and wherein the heat transfer medium is an oil or an electric heating element maintained at a temperature of about 150° F. or greater.

37. The vacuum neutralizing reactor of claim 33, wherein the heating device comprises an external heating jacket; and wherein the heat transfer medium is water or a glycol maintained at a temperature of about 150° F. or greater and a pressure of about 14.5 psia or greater.
